(19) United States
(12) Patent Application Publication
(10) Pub. No.: US 2017/0003710 A1
(43) Pub. Date: Jan. 5, 2017

(54) PORTABLE DISPLAY DEVICE

(71) Applicant: SIEMENS AKTIENGESELLSCHAFT, Munchen (DE)

(72) Inventors: Asa MacWILLIAMS, Fuerstenfeldbruck (DE); Timo WOLF, Schoeffelding (DE)

(73) Assignee: SIEMENS AKTIENGESELLSCHAFT, Munchen (DE)

(21) Appl. No.: 14/789,682

(22) Filed: Jul. 1, 2015

(51) Int. Cl. G06F 1/16; G06T 11/60; G06F 3/14; H04B 1/3827

(52) U.S. Cl. CPC G06F 1/163; H04B 1/385; G06T 11/60; G06F 3/14

(57) ABSTRACT

A digital screen operable to display one or more information fields is provided in a portable display device. One or more mechanical indicators, arranged in front of the digital screen, are operable to move along the digital screen. The portable display device is operable to visualize the one or more information fields on the digital screen as a function of a movement of the one or more mechanical indicators such that there is no overlap between the one or more mechanical indicators and the one or more information fields.

### BACKGROUND

Described below is a portable display device, i.e. a device which can be worn or carried by a user.

Portable display devices, particularly smartwatches or smartphones, have a plurality of functions. For using those functions, those devices comprise a digital screen for visualizing information to the user. However, for certain kinds of information and particularly for the time of day, many users would prefer mechanical indicators for displaying the information instead of a visualization on a digital screen. Nevertheless, a digital screen for other kinds of information shall still be included in the portable device.

### SUMMARY

Described below is a compact portable display device having both mechanical hands and a digital screen and providing a good readability of the information displayed on the device.

The portable display device has a digital screen or display being operable to display one or more information fields (i.e., fields indicating information for the user) thereon. Furthermore, one or more mechanical indicators are arranged in front of the digital screen, the mechanical indicators being operable to move along the digital screen.

The portable display device is operable to visualize the one or more information fields on the digital screen as a function of (i.e. depending on) a movement of the one or more mechanical indicators such that there is no overlap between the one or more mechanical indicators and the one or more information fields.

The portable display device is very compact because the mechanical indicators overlay a digital screen. However, it is ensured that the information fields on the digital screen will not be occluded by the mechanical indicators due to a coupling of the visualization of the information fields to the movement of the indicators so that an overlap between the indicators and the information fields does not occur.

In an embodiment, the portable display device is wearable by a user via a wristband. Furthermore, the one or more mechanical indicators may be a pair of hands for indicating the time of day. The pair of hands may be fixed at a pivot point in the center of the digital display. In other words, the portable display device may have the function of a smartwatch with the additional feature that the time of day is provided by conventional mechanical hands. This has the advantage of a good readability of the time of day in all light conditions. Furthermore, the portable display device supports the design of a classical mechanical watch which is often preferred by users.

In another embodiment, in plan view on the digital screen, the one or more mechanical indicators each lie entirely inside the digital screen. This ensures a compact design of the device.

In another embodiment, the portable display device is operable to change the position of at least one information field on the digital screen in order to prevent an overlap between the one or more mechanical indicators and the at least one information field. Here and in the following, the term “at least one information field” refers to at least one information field, particularly each information field, out of the one or more information fields visualized on the digital screen.

The change of the position of the at least one information field may be realized in different ways. In one embodiment, the change of the position of the at least one information field is visualized, at least temporarily, as a continuous movement of the at least information field. A continuous movement is a movement which is perceived by a user as a smooth movement without any discontinuous position variations. However, alternatively or additionally, the change of the position of the at least one information field may be visualized, at least temporarily, as a jump of the at least information field from one position to another on the digital screen. The term “jump” refers to a visualization which is perceived by a user as a discontinuous position change.

In another embodiment, the portable display device is operable to change the size of at least one information field on the digital screen in order to prevent an overlap between the one or more mechanical indicators and the at least one information field. Both the change of the position and the change of the size of the at least one information field may be used to avoid an overlap between the mechanical indicators and the information fields.

In a yet another embodiment, the change of the size of the at least one information field is visualized, at least temporarily, as a continuous size variation, i.e. a size variation perceived by a user as a continuous change of the size. Alternatively or additionally, the change of the size of the at least one information field is realized as an abrupt size variation, i.e. a size variation perceived by a user as a discontinuous size change.

In still another embodiment, the portable display device is operable in a first operation mode and a second operation mode. In the first operation mode, the digital screen is powered off or a static background is displayed on the digital screen. The static background may be displayed with low brightness. The first operation mode saves power of the portable display device. The first operation mode may be initiated manually by the user. However, alternatively or additionally, this operation mode may also be initiated automatically, e.g. in case that the user does not perform any user interactions with the device for a predetermined time period.

In the second operation mode, the one or more information fields are visualized on the digital screen as a function of a movement of the one or more mechanical indicators such that there is no overlap between the one or more mechanical indicators and the one or more information fields. Hence, in the second operation mode, the overlap between the indicators and the information fields is prevented. The brightness of the display in the second operation mode may be higher than in the first operation mode.

In yet another embodiment, the above mentioned static background displayed in the first operation mode is visualized as a clock face, e.g. by displaying lines and/or numbers on a circle around the pivot point of the mechanical hands. This embodiment supports the design of a classical watch which is often desired by a user.

In still another embodiment, the one or more information fields comprise at least one of the following information fields:
an information field for notifying a user about an incoming message;
an information field for notifying a user about a calendar event.

However, alternatively or additionally, other information fields for displaying other kinds of information may be used in the portable device. For example, an information field may refer to general information not associated with the user, e.g. weather information or information about stock prices and the like.

In yet another embodiment, the one or more information fields are displayed on the digital screen in response to a manual user interaction. Alternatively or additionally, the one or more information fields are displayed on the digital screen in response to an event not associated with a user interaction. For example, a predetermined context may be used in order to initiate the presentation of a specific information field on the screen. As an example, the information field indicating an upcoming calendar event may be displayed on the screen if the time period until the event is lower than a predetermined threshold.

In still another embodiment, the portable display device is operable in a configuration mode. Specifically, one or more of the following properties may be configured by a user in the configuration mode:
the number of information fields to be displayed on the digital screen;
the information content of at least one information displayed on the digital screen;
the visual appearance of at least one information field displayed on the digital screen.

In yet another embodiment, the device has a communication interface for coupling the device with an electronic unit, e.g. a smartphone. The communication interface may be a wireless interface, such as a Bluetooth interface. In a state in which the device is coupled to the electronic unit via the communication interface, one or more of the following pieces of information may be transmitted from the electronic unit to the device:
a piece of information for configuring the device; and
a piece of information comprising data to be presented in at least one information field.

In other words, for the use of certain operation modes, the device needs to be coupled to another electronic unit.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a plan view of a smartwatch illustrating a problem solved by the device; and

FIGS. 2-4 are plan views of an embodiment of a smartwatch in different operational states.

### DETAILED DESCRIPTION OF THE PREFERRED EMBODIMENTS

Reference will now be made in detail to the preferred embodiments, examples of which are illustrated in the accompanying drawings, wherein like reference numerals refer to like elements throughout.

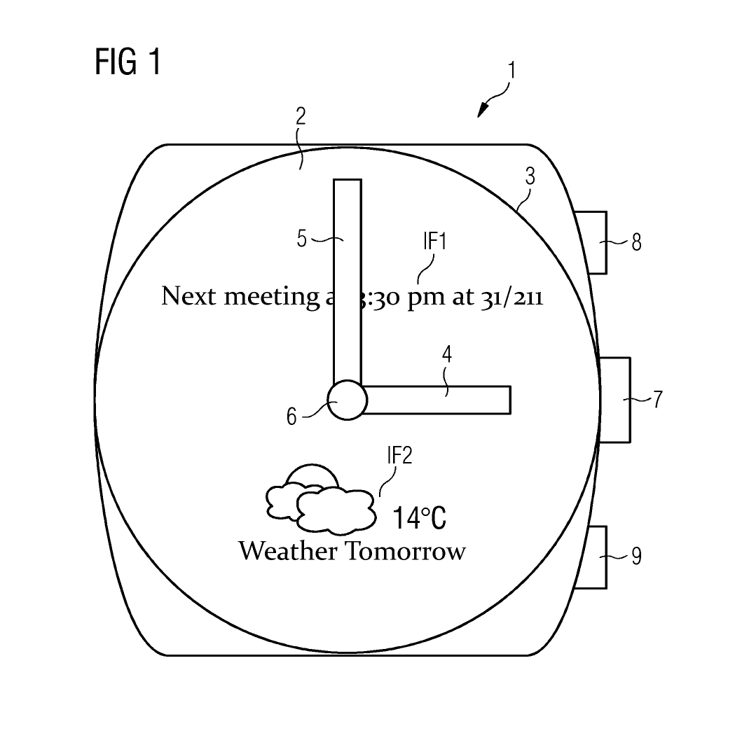

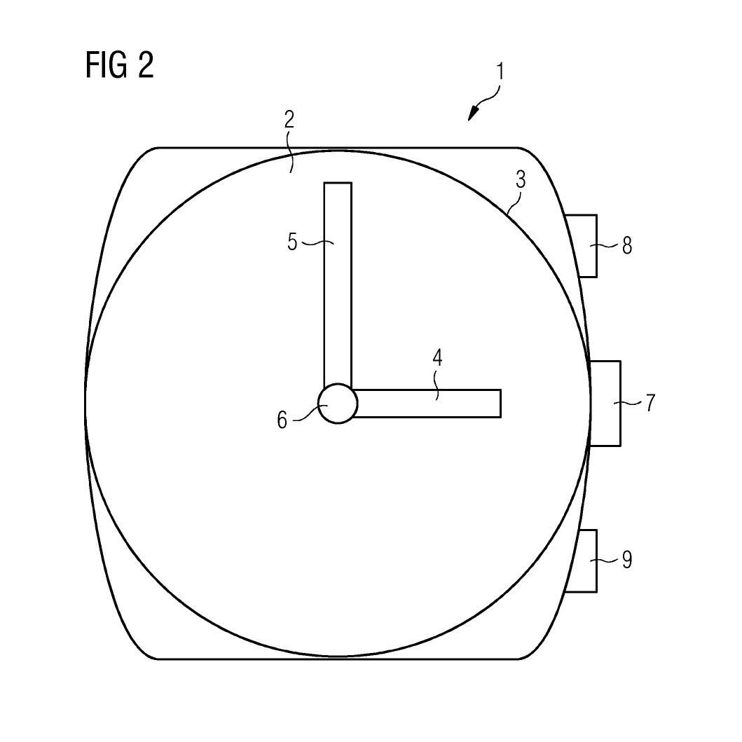

FIG. 1 is a schematic plan view of a smartwatch having the same hardware as the smartwatch based on an embodiment which will be described later on with respect to FIGS. 2-4. However, an essential software feature incorporated in the watch described below is missing in the smartwatch of FIG. 1.

The smartwatch of FIG. 1 comprises a body 1 which can be attached to the wrist of a user by a wristband which is not shown in FIG. 1. The watch comprises a digital display or screen 2 which has a circular shape bounded by the circular periphery 3. Two mechanical watch hands 4 and 5 are attached on a central pivot point 6 in front of the display 2 for indicating the time of day by rotating around the pivot point. Particularly, a small watch hand 4 is provided for indicating the hours and a big watch hand 5 is provided for indicating the minutes. Control elements 7, 8 and 9 are provided at the right side of the watch enabling a user to interact with the watch. The control elements comprise a central mechanical watch crown 7 as well as an upper button 8 and a lower button 9. The use of these control elements for interacting with functions of the watch is not essential for the invention and, thus, will not be described in detail.

In the operation mode shown in FIG. 1, two information fields IF1 and IF2 are visualized on the digital screen 2. The information field IF1 informs the user about the time and the location of an upcoming meeting by a corresponding text. The upcoming event is a meeting at 3:30 p.m. in room 31/211. The information field IF2 informs the user about the expected weather conditions for the next day. Those weather conditions are visualized by a pictogram as well as the textual information of the temperature of the next day, namely 14° C.

The software of the watch of FIG. 1 displays the information fields IF1 and IF2 at a fixed location on the screen 2. This arises in the problem that essential information of the information fields may be covered by the mechanical hands indicating the time. In the scenario of FIG. 1, the big hand 5 extends in the upward direction and covers a part of the meeting time of information field IF1. Hence, the user cannot see the exact meeting time though this time is displayed on the digital screen 2. This problem is overcome by the watch according to the embodiment as described in the following.

FIG. 2 shows an embodiment of a smartwatch. The mechanical structure of the watch is identical to FIG. 1. This means, analogously to the watch of FIG. 1, the watch of FIG. 2 comprises a body 1 with a display 2 having a circular boundary 3 where a small hand 4 and a big hand 5 are attached at a pivot point 6 in front of the display. Furthermore, analogously to FIG. 1, control elements 7, 8 and 9, namely a mechanical crown 7 and buttons 8 and 9, are arranged at the right side of the watch of FIG. 2, as it is the case for the watch of FIG. 1.

In the operation mode of FIG. 2, only the time of day is shown on the watch. In other words, the display 2 is switched off so that a user can only read the time of day via the positions of the hands 4 and 5. In this operation mode, the energy consumption of the watch is very low resulting in a long battery runtime. The operation mode shown in FIG. 2 may be initiated by the user or may be activated automatically in case that no user interactions with the watch are performed by the control elements 7, 8 or 9 for a longer time period.

In an alternative embodiment, the display 2 may also be switched on in the operation mode of FIG. 2, e.g., with a reduced brightness. For example, a uniform background color may be generated on the display. Moreover, a clock face may be visualized on the display so that the user has the impression that he wears a conventional mechanical watch. The clock face may include lines and/or numbers making it easier for the user to identify the correct time of day.

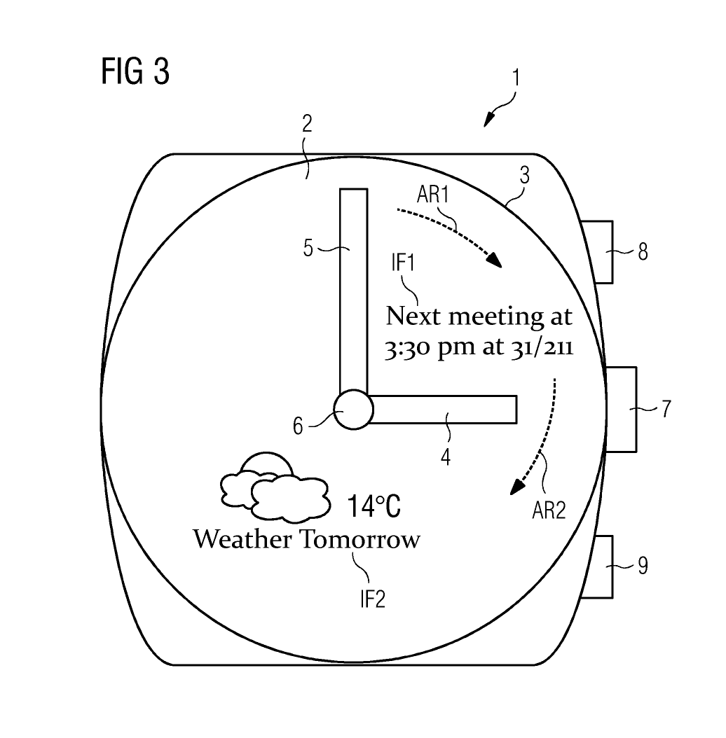

FIG. 3 shows the watch of FIG. 2 in another operation mode in which the information fields IF1 and IF2 already shown in FIG. 1 are displayed on the display 2. Contrary to the watch of FIG. 1, the position of the information fields IF1 and IF2 is chosen such that the watch hands 4 and 5 do not overlap with the information fields IF1 and IF2. This is achieved by corresponding software analyzing the movement of the watch hands and placing the information fields IF1 and IF2 dynamically at positions on the display 2 not overlapping with the watch hands. Hence, it is possible for the user to read the meeting time 3:30 p.m. in the information field IF1, contrary to the watch of FIG. 1, where a part of the meeting time was covered by the long hand 5.

FIG. 3 also shows two dashed arrows AR1 and AR2 pointing in a clock-wise direction and not being part of the visualization on the display 2. The arrows are used to illustrate that the information field IF1 will dynamically move as a function of the movement of the hands 4 and 5 in order to prevent an overlap between the information fields and the hands. Particularly, when the long hand 5 continues to move to the right, a point will be reached at which the display of the information field IF1 between the small hand 4 and the long hand 5 is no longer possible. Hence, at a certain predefined position of the long hand 5, the information field IF1 will switch to another position on the digital screen, e.g. to the position at the left of the long hand 5.

Analogously to the information field IF1, the information field IF2 will also move as a function of the movement of the hands 4 and 5 in order to prevent an overlap between the hands and the information field IF2. In other words, when one of the hands approaches the information field IF2, a movement of the information field and/or a switch of the information field to another position (if necessary) will be initiated by a corresponding software within the watch.

The operation mode shown in FIG. 3 may be initiated automatically or by a manual interaction of the user. For example, when the time 3:30 p.m. of the meeting according to information field IF1 approaches, the watch may switch automatically from the operation mode of FIG. 2 to the operation mode of FIG. 3 in order to inform the user about the upcoming meeting.

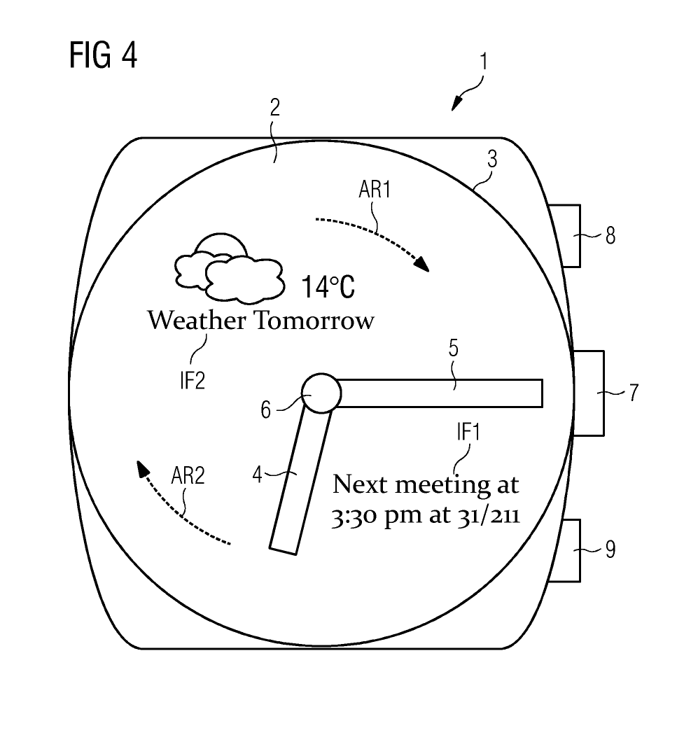

FIG. 4 shows the watch of FIG. 3 in the same operation mode as in FIG. 3 but at a different time of day. As can be seen from FIG. 4, due to the change of time, the respective information fields IF1 and IF2 have been moved to other positions in the clock-wise direction as indicated by arrows AR1 and AR2. Particularly, the information field IF1 is now placed in the lower right portion of the display, contrary to FIG. 3 where the information field IF1 is positioned at an upper right portion of the display. Furthermore, the information field IF2 is positioned in FIG. 4 at an upper left portion on the display whereas this information field is positioned in FIG. 3 at a lower left portion. Evidently, the positions of the information fields IF1 and IF2 in FIG. 4 have been chosen by the corresponding software such that no overlap occurs between the hands and the information fields as it is the case in FIG. 3.

The smartwatch as described in the foregoing has several advantages. A dynamic user interface layout management is provided preventing an overlap of mechanical hands in a smartwatch with digital information displayed on a display of the smartwatch. To do so, digital information, such as information about upcoming events or notifications, is displayed in a way so that this information is not below the mechanical hands. The digital information moves with the rotation of the hands. In contrast to existing smartwatches that have either mechanical hands or a digital display, the watch has both. Thus, the watch supports the design of a classical watch showing the time in all light conditions as well as the ability to display digital information on a digital screen when needed.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A portable display device, comprising:
a digital screen operable to display at least one information field; and
at least one mechanical indicator arranged in front of the digital screen and operable to move above the digital screen, the digital screen displaying the at least one information field as a function of movement of the at least one mechanical indicator while avoiding overlap between the at least one mechanical indicator and the at least one information field.

2. The portable display device according to claim 1, wherein the portable display device is wearable by a user via a wristband.

3. The portable display device according to claim 1, wherein the at least one mechanical indicator includes a pair of hands indicating time of day.

4. The portable display device according to claim 3, wherein the display screen in a first operation mode displays a clock face as a static background.

5. The portable display device according to claim 1, wherein, in plan view on the digital screen, each of the at least one mechanical indicator is entirely in front of the digital screen.

6. The portable display device according to claim 1, wherein the portable display device is operable to change a position of the at least one information field on the digital screen to prevent the overlap between the at least one mechanical indicator and the at least one information field.

7. The portable display device according to claim 6, wherein the change of the position of the at least one information field on the digital screen is visualized, at least temporarily, as one of a continuous movement of the at least one information field on the digital screen and a jump of the at least one information field from a first position to a second position on the digital screen.

8. The portable display device according to claim 1, wherein the portable display device is configured to change a size of the at least one information field on the digital screen to prevent the overlap between the at least one mechanical indicator and the at least one information field.

9. The portable display device according to claim 8, wherein the change of the size of the at least one information field on the digital screen is visualized, at least temporarily, as at least one of a continuous size variation and an abrupt size variation.

10. The portable display device according to claim 1, wherein the portable display device has a first operation mode displaying a static background on the digital screen when the digital screen is not powered off, and a second operation mode displaying the at least one information field on the digital screen as a function of a movement of the at least one mechanical indicator to prevent the overlap between the at least one mechanical indicator and the at least one information field.

11. The portable display device according to claim 10, wherein the display screen in the first operation mode displays a clock face as the static background.

12. The portable display device according to claim 1, wherein the at least one information field includes at least one of a first information field for notifying a user about an incoming message and a second information field for notifying a user about a calendar event.

13. The portable display device according to claim 1, wherein the at least one information field is displayed on the digital screen in response to at least one of a manual user interaction and an event not associated with any user interaction.

14. The portable display device according to claim 1, wherein the device is operable in a configuration mode in which a user configures at least one of
a number of information fields to be displayed on the digital screen,
information content of the at least one information field, and
a visual appearance of the at least one information field.

15. The portable display device according to claim 1, further comprising a communication interface capable of coupling the device with an electronic unit.

16. The portable display device according to claim 15, wherein, when the device is coupled to the electronic unit, the communication interface transmits, from the electronic unit to the device, at least one of configuration information and data to be presented in the at least one information field.
